(19) United States
(12) Patent Application Publication
(10) Pub. No.: US 2012/0081791 A1
(43) Pub. Date: Apr. 5, 2012

(54) WIDE-ANGLE LENS, IMAGING APPARATUS, AND METHOD FOR MANUFACTURING WIDE-ANGLE LENS

(75) Inventors: ISSEI TANAKA, Yokohama-shi (JP); Haruo Sato, Kawaguchi-shi (JP)

(73) Assignee: NIKON CORPORATION

(21) Appl. No.: 13/249,574

(22) Filed: Sep. 30, 2011

(30) Foreign Application Priority Data
Oct. 1, 2010 (JP) 2010-223594

(51) Int. Cl. G02B 13/04; G02B 1/11; B23P 25/00; G02B 13/18

(52) U.S. Cl. 359/581; 359/717; 29/458

(57) ABSTRACT

Including: a front group Gf disposed to an object side of an aperture; and a rear group Gr disposed to an image side of the aperture; the front group including a sub group Ga having negative power, the sub group including, from the object side, at least three negative lenses, at least one of the three negative lens being an aspherical negative meniscus lens having a shape that negative power is getting smaller from the center to the periphery, a cemented lens constructed by a positive lens, a negative lens and a positive lens disposed to the image side of the sub group, an antireflection coating being applied on at least one surface of the front group, the antireflection coating including at least one layer formed by a wet process, and given conditions being satisfied, thereby providing a wide-angle lens having high optical performance with a large angle of view.

The disclosure of the following priority application is herein incorporated by reference:

Japanese Patent Application No. 2010-223594 filed on Oct. 1, 2010.

### BACKGROUND OF THE INVENTION

1. Field of the Invention

The present invention relates to a wide-angle lens suitable for an image-taking lens, an imaging apparatus, and a method for manufacturing the wide-angle lens.

2. Related Background Art

There has been proposed a retrofocus-type wide-angle lens (hereinafter simply called as a wide-angle lens in the present specification) used for a camera in such as Japanese Patent Application Laid-Open No. 2001-159732.

Regarding such a wide-angle lens, request for suppressing ghost images and flare, which deteriorate optical performance, as well as aberrations become increasingly strong. Accordingly, a higher optical performance is required to antireflection coatings applied to a lens surface, so that in order to meet such request, multilayer design technology and multilayer coating technology are continuously progressing (for example, see Japanese Patent Application Laid-Open No. 2000-356704).

However, the conventional wide-angle lens has had a problem that when a large angle of view is to be realized, it becomes difficult to keep high optical performance. In addition, there is a problem that reflection light producing ghost images and flare is liable to be generated from optical surfaces in such a wide-angle lens.

### SUMMARY OF THE INVENTION

The present invention is made in view of the above-described problems, and has an object to provide a wide-angle lens having excellent optical performance with realizing a large angle of view and further suppressing ghost images and flare, an imaging apparatus equipped therewith, and a method for manufacturing the wide-angle lens.

According to a first aspect of the present invention, there is provided a wide-angle lens comprising: a front lens group disposed to an object side of an aperture stop; and a rear lens group disposed to an image side of the aperture stop; the front lens group including a sub-lens group having negative refractive power, the sub-lens group including, in order from the most object side, at least three negative lenses, at least one of the three negative lenses being an aspherical negative meniscus lens, the aspherical negative meniscus lens having a shape that negative refractive power is getting smaller from the center to the periphery, a cemented lens constructed by a positive lens cemented with a negative lens cemented with a positive lens being disposed to the image side of the sub-lens group, and the following conditional expressions (1) and (2) being satisfied, and an antireflection coating being applied on at least one optical surface of the front lens group, and the antireflection coating including at least one layer that is formed by a wet process:

0.30<|Rasp/hasp<0.90 (1)

−1.00<(Rr+Rf)/(Rr−Rf)<0.00 (2)

where Rasp denotes a paraxial radius of curvature of an aspherical surface of the aspherical negative meniscus lens having the shape that negative refractive power is getting smaller from the center to the periphery, hasp denotes a half of an effective diameter (maximum effective radius) of the aspherical negative meniscus lens having the shape that negative refractive power is getting smaller from the center to the periphery, Rr denotes a radius of curvature of the image side surface of the negative lens in the cemented lens, and Rf denotes a radius of curvature of the object side surface of the negative lens in the cemented lens.

According to a second aspect of the present invention, there is provided an imaging apparatus equipped with the wide-angle lens according to the first aspect.

According to a third aspect of the present invention, there is provided a method for manufacturing a wide-angle lens including a front lens group disposed to an object side of an aperture stop, and a rear lens group disposed to an image side of the aperture stop comprising steps of: disposing optical members including at least three negative lenses including an aspherical negative meniscus lens having a shape that negative refractive power is getting weaker from the center to the periphery in the object side sub-lens group in the front lens group; disposing optical members including a cemented lens constructed by a positive lens, a negative lens, and a positive lens to the image side of the sub-lens group; satisfying the following conditional expressions (1) and (2):

0.30<|Rasp|/hasp<0.90 (1)

−1.00<(Rr+Rf)/(Rr−Rf)<0.00 (2)

where Rasp denotes a paraxial radius of curvature of an aspherical surface of the aspherical negative meniscus lens having the said shape, hasp denotes a half of an effective diameter (maximum effective radius) of the aspherical negative meniscus lens having the said shape, Rr denotes a radius of curvature of the image side surface of the negative lens in the cemented lens, and Rf denotes a radius of curvature of the object side surface of the negative lens in the cemented lens; and applying an antireflection coating on at least one optical surface of the front lens group, in which the antireflection coating includes at least one layer that is formed by a wet process.

The present invention makes it possible to provide a wide-angle lens having high optical performance with having a large angle of view, an imaging apparatus, and a method for manufacturing the wide-angle lens.

### BRIEF DESCRIPTION OF THE DRAWINGS

FIG. 1 is a sectional view showing a lens configuration of a wide-angle lens focusing on infinity according to Example 1 of the present embodiment.

FIG. 2 shows graphs of various aberrations of the wide-angle lens according to Example 1 upon focusing on infinity.

FIG. 3 is a sectional view showing the lens configuration of the wide-angle lens according to Example 1 and is an explanatory view, in which light rays reflected from a first-ghost-generating surface are reflected by a second-ghost-generating surface.

FIG. 4 is a sectional view showing a lens configuration of a wide-angle lens focusing on infinity according to Example 2 of the present embodiment.

FIG. 5 shows graphs of various aberrations of the wide-angle lens according to Example 2 upon focusing on infinity.

FIG. 6 is a sectional view showing a lens configuration of a wide-angle lens focusing on infinity according to Example 3 of the present embodiment.

FIG. 7 shows graphs of various aberrations of the wide-angle lens according to Example 3 upon focusing on infinity.

FIG. 8 is a diagram showing a construction of a camera equipped with the wide-angle lens according to Example 1 of the present embodiment.

FIG. 9 is a flowchart showing a method for manufacturing a wide-angle lens according to the present embodiment.

FIG. 10 is an explanatory view showing a configuration of an antireflection coating according to the present application.

FIG. 11 is a graph showing spectral reflectance of an antireflection coating according to the present application.

FIG. 12 is a graph showing spectral reflectance of an antireflection coating according to a variation of the present application.

FIG. 13 is a graph showing incident angle dependency of spectral reflectance of the antireflection coating according to the variation.

FIG. 14 is a graph showing spectral reflectance of an antireflection coating according to a conventional example.

FIG. 15 is a graph showing incident angle dependency of spectral reflectance of the antireflection coating according to the conventional example.

### DESCRIPTION OF THE MOST PREFERRED EMBODIMENT

A wide-angle lens according to the present embodiment is explained below. The following embodiment only shows for better understandings of the present invention. Accordingly, any operable addition or conversion capable of being carried out by a person having ordinary skill in the art is not intended to be excluded within a scope of the present invention.

A wide-angle lens according to the present embodiment includes, a front lens group disposed to an object side of an aperture stop, and a rear lens group disposed to an image side of the aperture stop. The front lens group includes a sub-lens group having negative refractive power. The sub-lens group includes, in order from the most object side, at least three negative lenses. At least one lens among the at least three negative lenses is constructed by an aspherical negative meniscus lens. The aspherical negative meniscus lens has a shape whose negative refractive power is getting smaller from the center to the periphery. A cemented lens constructed by a positive lens, a negative lens, and a positive lens is disposed to the image side of the sub-lens group. The following conditional expressions (1) and (2) are satisfied:

0.30<|Rasp|/hasp<0.90 (1)

−1.00<(Rr+Rf)/(Rr−Rf)<0.00 (2)

where Rasp denotes a paraxial radius of curvature of an aspherical surface of the aspherical negative meniscus lens having the shape, hasp denotes a half of an effective diameter (maximum effective radius) of the aspherical negative meniscus lens having the shape, Rr denotes a radius of curvature of the image side surface of the negative lens in the cemented lens, and Rf denotes a radius of curvature of the object side surface of the negative lens in the cemented lens.

With this construction, a wide-angle lens according to the present embodiment makes it possible to accomplish a large angle of view and compactness, and to obtain high optical performance.

In a wide-angle lens according to the present embodiment, the sub-lens group in the front lens group includes at least one aspherical negative meniscus lens having a large aspherical amount. Accordingly, with correcting various aberrations by the aspherical negative meniscus lens, it becomes possible to excellently correct various aberrations, in particular, astigmatism, curvature of field, coma, and distortion, as well as to accomplish a large angle of view and compactness. Incidentally, the aspherical amount denotes an amount of displacement of an aspherical surface from a spherical surface.

Conditional expression (1) relates to an aspherical amount of the aspherical negative meniscus lens having a shape whose negative refractive power is getting smaller from the center to the periphery. With satisfying conditional expression (1), it becomes possible to realize a wide-angle lens having high optical performance and a large angle of view with being compact. When a value which is a paraxial radius of curvature of an aspherical surface of the aspherical negative meniscus lens having the shape whose negative refractive power is getting smaller from the center to the periphery (|Rasp|) is divided by a half of an effective diameter of the aspherical negative meniscus lens (hasp) is equal to or falls below 1.00, it means exceeding a half sphere in a spherical surface. In the case of an aspherical surface, the smaller the value becomes, the larger the aspherical amount becomes. Accordingly, it is important to define the value for realizing a wide-angle lens having a large angle of view and compactness.

When the value |Rasp|/hasp is equal to or exceeds the upper limit of conditional expression (1), the aspherical amount becomes small, and the shape does not exceed a half sphere, so that the aspherical amount of the aspherical surface becomes further smaller. As a result, in a wide-angle lens according to the present embodiment, the aspherical amount does not become sufficient to correct aberrations, so that it becomes difficult to correct various aberrations, in particular, curvature of field, astigmatism, and coma.

In order to excellently correct various aberrations, it is preferable to set the upper limit of conditional expression (1) to 0.80. In order to further excellently correct various aberrations, it is preferable to set the upper limit of conditional expression (1) to 0.73. In order to still further excellently correct various aberrations, it is preferable to set the upper limit of conditional expression (1) to 0.70, so that the effect of the present invention can fully be exhibited.

On the other hand, when the value |Rasp|/hasp is equal to or falls below the lower limit of conditional expression (1), the aspherical amount of the aspherical negative meniscus lens becomes excessively large, so that it becomes difficult to manufacture the aspherical surface. Moreover, a curve of distortion becomes excessively large. Incidentally, the curve denotes difference in the aberration amount with respect to the height of the image.

With setting the lower limit of conditional expression (1) to 0.35, the curvature of distortion can be suppressed, and manufacturing the aspherical surface does not become difficult. Moreover, with setting lower limit of conditional expression (1) to 0.40, the effect of the present invention can be exhibited. Furthermore, with setting lower limit of conditional expression (1) to 0.50, the effect of the present invention can fully be exhibited.

Conditional expression (2) defines an appropriate range of a shape factor (q-factor) of the negative lens in the cemented lens of a positive-negative-positive construction in the front lens group. With satisfying conditional expression (2), it becomes possible to accomplish a wide-angle lens having high optical performance with securing a sufficient back focal length.

In a negative lens, when the shape factor is −1.00, the lens is a plano-concave lens having a plane surface facing the object side. When the shape factor is 0.00, the lens is a double concave negative lens, in which the absolute value of the radius of curvature of the object side lens surface is the same as that of the image side lens surface. Accordingly, in a wide-angle lens according to the present embodiment, the negative lens in the cemented lens becomes a double concave negative lens whose absolute value of the radius of curvature of the object side lens surface is always larger than that of the image side lens surface. A cemented lens having such a negative lens has an effect to excellently correct various aberrations, in particular, coma, curvature of field, and lateral chromatic aberration. With this negative lens, it becomes possible to locate the principal point to the image side. As a result, with the effect of the cemented-lens together with the effect of the negative lens in the sub-lens group in the front lens group, a wide-angle lens according to the present embodiment makes it possible to realize extremely large retrofocus ratio and to secure sufficient back focal length. Incidentally, the retrofocus ratio means a ratio of the focal length F0 of the wide-angle lens to the back focal length BF that is F0/BF.

When the value (Rr+Rf)/(Rr−Rf) is equal to or exceeds the upper limit of conditional expression (2), the negative lens in the cemented lens becomes a double concave negative lens having a shape that the absolute value of the radius of curvature of the object side lens surface is smaller than that of the image side lens surface. However, with the negative lens having such a shape, it becomes impossible to locate the principal point to the image side. Moreover, the curves (difference in the values with respect to the image heights) of the coma, curvature of field and lateral chromatic aberration become worse, so that it becomes impossible to accomplish a large angle of view.

With setting the upper limit of conditional expression (2) to −0.01, it becomes possible to excellently correct coma, curvature of field, and lateral chromatic aberration, so that the effect of the present invention can be secured. With setting the upper limit of conditional expression (2) to −0.05, it becomes possible to excellently correct these aberrations, so that the effect of the present invention can be further secured. With setting the upper limit of conditional expression (2) to −0.11, it becomes possible to further excellently correct these aberrations, so that the effect of the present invention can be still further secured. With setting the upper limit of conditional expression (2) to −0.15, the effect of the present invention can fully be exhibited.

On the other hand, when the value (Rr+Rf)/(Rr−Rf) is equal to or falls below the lower limit of conditional expression (2), the negative lens in the cemented lens becomes a plano-concave lens having a plane surface facing the object side. When the value (Rr+Rf)/(Rr−Rf) further falls below the lower limit of conditional expression (2), the negative lens becomes a meniscus shape having a convex surface facing the object side. When the object side lens surface becomes a convex surface, aberration correction effect of the object side cemented surface of the negative lens in the cemented lens becomes insufficient, so that it becomes impossible to excellently correct various aberrations, in particular, coma, lateral chromatic aberration, and spherical aberration become worse.

With setting the lower limit of conditional expression (2) to −0.90, it becomes possible to excellently correct various aberrations such as coma, so that the effect of the present invention can be secured. With setting the lower limit of conditional expression (2) to −0.80, it becomes possible to excellently correct various aberrations such as coma, so that the effect of the present invention can be further secured. With setting the lower limit of conditional expression (2) to −0.70, it becomes possible to further excellently correct various aberrations such as coma, and the effect of the present invention can fully be exhibited.

In a wide-angle lens according to the present embodiment, at least one optical surface among the front lens group is applied with an antireflection coating, and the antireflection coating includes at least one layer that is formed by a wet process. With this configuration, a wide-angle lens according to the present embodiment makes it possible to suppress ghost images and flare generated by the light rays from the object reflected from the optical surfaces in the front lens group, thereby realizing excellent optical performance.

Moreover, in a wide-angle lens according to the present embodiment, the antireflection coating formed on the optical surface in the front lens group is a multilayered film, and the layer formed by the wet process is preferably the outermost layer among the layers composing the multilayered film. With this configuration, since difference in refractive index with respect to the air can be small, reflection of light can be small, so that ghost images and flare can further be suppressed.

In a wide-angle lens according to the present embodiment, a refractive index at d-line of the layer formed by the wet process is preferably 1.30 or less. With this configuration, since difference in refractive index with respect to the air can be small, reflection of light can be small, so that ghost images and flare can further be suppressed.

Moreover, in a wide-angle lens according to the present embodiment, the optical surface on which the antireflection coating is applied is preferably a lens surface in the front lens group. Since reflection light rays are liable to be generated on a lens surface disposed to the object side of an aperture stop, with applying the antireflection coating on such an optical surface, ghost images and flare can effectively be suppressed.

Moreover, in a wide-angle lens according to the present embodiment, the optical surface on which the antireflection coating is applied is preferably a lens surface of the sub-lens group having negative refractive power in the front lens group. Since reflection light rays are liable to be generated on a lens surface of a lens having negative refractive power, with applying the antireflection coating on such an optical surface, ghost images and flare can effectively be suppressed.

Moreover, in a wide-angle lens according to the present embodiment, the optical surface on which the antireflection coating is applied is preferably an object side lens surface of a convex surface facing the object side in the front lens group. Since reflection light rays are liable to be generated on an object side lens surface of a convex surface facing the object side, with applying the antireflection coating on such an optical surface, ghost images and flare can effectively be suppressed.

Moreover, in a wide-angle lens according to the present embodiment, the optical surface on which the antireflection coating is applied is preferably an image side lens surface of a concave surface facing the image side in the front lens group. Since reflection light rays are liable to be generated on an image side lens surface of a concave surface facing the image side, with applying the antireflection coating on such an optical surface, ghost images and flare can effectively be suppressed.

Moreover, in a wide-angle lens according to the present embodiment, the optical surface on which the antireflection coating is applied is preferably a lens surface of the aspherical negative meniscus lens in the front lens group. Since reflection light rays are liable to be generated on a lens surface of a negative meniscus lens, with applying the antireflection coating on such an optical surface, ghost images and flare can effectively be suppressed.

Moreover, in a wide-angle lens according to the present embodiment, the antireflection coating may also be formed by a dry process etc without being limited to the wet process. On this occasion, it is preferable that the antireflection coating contains at least one layer of which the refractive index is equal to 1.30 or less. Thus, the same effects as in the case of using the wet process can be obtained by forming the antireflection coating based on the dry process etc. Note that at this time the layer of which the refractive index is equal to 1.30 or less is preferably the layer of the outermost surface of the layers composing the multi-layered film.

In a wide-angle lens according to the present embodiment, the following conditional expression (3) is preferably satisfied:

0.00<Ff/F0<11.00 (3)

where Ff denotes a focal length of the front lens group upon focusing on infinity, and F0 denotes a focal length of the wide-angle lens upon focusing on infinity.

Conditional expression (3) defines an appropriate range of the focal length of the front lens group. With satisfying conditional expression (3), it becomes possible to realize a wide-angle lens having high optical performance with a large angle of view.

In a wide-angle lens according to the present embodiment, refractive power of the front lens group is positive, and large refractive power is disposed to the front lens group. With disposing large positive refractive power to the front lens group, it becomes possible to construct a retrofocus-type wide-angle lens having considerable refractive power in the front lens group.

When the ratio Ff/F0 is equal to or exceeds the upper limit of conditional expression (3), refractive power of the front lens group becomes small, and refractive power distribution of a retrofocus-type becomes weak, so that the total lens length of a wide-angle lens becomes large. Accordingly, when it is forcibly shortened, spherical aberration and coma become worse.

With setting the upper limit of conditional expression (3) to 9.00, it becomes possible to excellently correct various aberrations, in particular, spherical aberration and coma with accomplishing compactness, so that the effect of the present invention can be secured. With setting the upper limit of conditional expression (3) to 7.00, it becomes possible to further excellently correct various aberrations, in particular, spherical aberration and coma, so that the effect of the present invention can be further secured. With setting the upper limit of conditional expression (3) to 5.00, it becomes possible to further excellently correct various aberrations, in particular, spherical aberration and coma, and the effect of the present invention can fully be exhibited.

On the other hand, when the ratio Ff/F0 is equal to or falls below the lower limit of conditional expression (3), the focal length of the front lens group upon focusing on infinity becomes negative value, so that optimum refractive power distribution is lost, and the front lens group disposed up to right before the aperture stop comes to have negative refractive power. As a result, spherical aberration, coma, in particular, upper coma become worse.

With setting the lower limit of conditional expression (3) to 0.10, it becomes possible to excellently correct various aberrations such as spherical aberration and coma, in particular, upper coma, so that the effect of the present invention can be secured. With setting the lower limit of conditional expression (3) to 0.20, it becomes possible to further excellently correct various aberrations such as spherical aberration and coma, in particular, upper coma, so that the effect of the present invention can be further secured. With setting the lower limit of conditional expression (3) to 0.50, it becomes possible to further excellently correct various aberrations such as spherical aberration and coma, in particular, upper coma, so that the effect of the present invention can fully be exhibited.

In a wide-angle lens according to the present embodiment, the following conditional expression (4) is preferably satisfied:

−0.30<F0/Fb<0.50 (4)

where F0 denotes a focal length of the wide-angle lens upon focusing on infinity, and Fb denotes a focal length of the cemented lens.

Conditional expression (4) defines an appropriate range of refractive power of the cemented lens in the front lens group. With satisfying conditional expression (4), it becomes possible to realize a wide-angle lens having high optical performance in spite of having compactness and a large angle of view.

In a wide-angle lens according to the present embodiment, with giving large refractive power to the negative lens in the cemented lens, positive refractive power of the cemented lens is made to be small. Moreover, in a wide-angle lens according to the present embodiment, negative refractive power is given to the cemented lens, so that it becomes possible to realize a large angle of view and compactness.

When the ratio F0/Fb is equal to or exceeds the upper limit of conditional expression (4), refractive power of the negative lens in the cemented lens becomes small, and positive refractive power of the cemented lens becomes large. As a result, the retrofocus ratio becomes small, so that it becomes difficult to secure the back focal length. Moreover, lateral chromatic aberration becomes worse.

With setting the upper limit of conditional expression (4) to 0.40, it becomes possible to excellently correct lateral chromatic aberration, so that the effect of the present invention can be secured. With setting the upper limit of conditional expression (4) to 0.30, it becomes possible to further excellently correct lateral chromatic aberration, so that the effect of the present invention can be further secured. With setting the upper limit of conditional expression (4) to 0.25, it becomes possible to further excellently correct lateral chromatic aberration, and the effect of the present invention can fully be exhibited.

On the other hand, when the ratio F0/Fb is equal to or falls below the lower limit of conditional expression (4), refractive power of the negative lens in the cemented lens becomes excessively large, and negative refractive power of the cemented lens becomes large, so that curvatures of curvature of field, distortion, and lateral chromatic aberration become worse.

With setting the lower limit of conditional expression (4) to −0.20, it becomes possible to excellently correct various aberrations, in particular, curvature of field, distortion and lateral chromatic aberration, so that the effect of the present invention can be secured. With setting the lower limit of conditional expression (4) to −0.10, it becomes possible to further excellently correct various aberrations, in particular, curvature of field, distortion and lateral chromatic aberration, so that the effect of the present invention can be further secured. With setting the lower limit of conditional expression (4) to −0.15, it becomes possible to further excellently correct various aberrations, in particular, curvature of field, distortion and lateral chromatic aberration, and the effect of the present invention can fully be exhibited.

In a wide-angle lens according to the present embodiment, the sub-lens group preferably includes an aspherical lens other than the aspherical negative meniscus lens. With this construction, it becomes possible to excellently correct off-axis aberrations, in particular, distortion, curvature of field, and coma.

In a wide-angle lens according to the present embodiment, the aspherical lens preferably has larger negative refractive power on the periphery than at the center of the lens. Since such an aspherical surface and the above-described aspherical negative meniscus lens (in which negative refractive power is getting smaller from the center to the periphery) have opposite aspherical effect with each other, with combining them, a wide-angle lens according to the present embodiment makes it possible to excellently correct curvature of field, astigmatism and coma with accomplishing a large angle of view. Incidentally, a portion where negative refractive power becomes lager than the central portion is preferably the most peripheral portion.

In a wide-angle lens according to the present embodiment, the following conditional expression (5) is preferably satisfied:

0.01<(−Fa)/BF<0.80 (5)

where Fa denotes a focal length of the sub-lens group, and BF denotes a distance from a vertex of the most image side lens surface to a paraxial image plane (a back focal length).

Conditional expression (5) defines an appropriate range of the focal length (refractive power) of the sub-lens group of a wide-angle lens according to the present embodiment. With satisfying conditional expression (5), it becomes possible to realize a wide-angle lens having high optical performance and compactness with securing a back focal length.

When the ratio (−Fa)/BF is equal to or exceeds the upper limit of conditional expression (5), the focal length of the sub-lens group becomes large, and refractive power of the sub-lens group becomes small. In this case, the retrofocus ratio becomes small, so that it becomes difficult to secure the back focal length. Moreover, the front lens group becomes large, so that the wide-angle lens becomes large. On this occasion, when the lens is forcibly made compact or the back focal length is forcibly secured, off-axis aberrations such as coma become worse.

With setting the upper limit of conditional expression (5) to 0.70, the effect of the present invention can be secured. With setting the upper limit of conditional expression (5) to 0.50, the effect of the present invention can further be secured. With setting the upper limit of conditional expression (5) to 0.40, the effect of the present invention can fully be exhibited.

On the other hand, when the ratio (−Fa)/BF is equal to or falls below the lower limit of conditional expression (5), the focal length of the sub-lens group becomes small, and refractive power of the sub-lens group becomes large. When refractive power of the sub-lens group becomes excessively large, distortion, curvature of field and coma become worse.

With setting the lower limit of conditional expression (5) to 0.10, it becomes possible to excellently correct various aberrations such as distortion, curvature of field and coma, so that the effect of the present invention can be secured. With setting the lower limit of conditional expression (5) to 0.15, it becomes possible to further excellently correct various aberrations such as distortion, curvature of field and coma, so that the effect of the present invention can be further secured. With setting the lower limit of conditional expression (5) to 0.20, it becomes possible to further excellently correct various aberrations such as distortion, curvature of field and coma, and the effect of the present invention can fully be exhibited.

In a wide-angle lens according to the present embodiment, the following conditional expression (6) is preferably satisfied:

4.00<Fr/F0<50.00 (6)

where Fr denotes a focal length of the rear lens group upon focusing on infinity, and F0 denotes a focal length of the wide-angle lens upon focusing on infinity.

Conditional expression (6) defines an appropriate range of the focal length (refractive power) of the rear lens group. With satisfying conditional expression (6), it becomes possible to realize a wide-angle lens having high optical performance.

When the ratio Fr/F0 is equal to or exceeds the upper limit of conditional expression (6), refractive power of the rear lens group becomes small, and distortion and coma become worse.

With setting the upper limit of conditional expression (6) to 40.00, it becomes possible to excellently correct various aberrations such as distortion and coma, so that the effect of the present invention can be secured. With setting the upper limit of conditional expression (6) to 35.00, it becomes possible to further excellently correct various aberrations such as distortion and coma, so that the effect of the present invention can be further secured. With setting the upper limit of conditional expression (6) to 30.00, it becomes possible to further excellently correct various aberrations such as distortion and coma, so that the effect of the present invention can fully be exhibited.

On the other hand, when the ratio Fr/F0 is equal to or falls below the lower limit of conditional expression (6), refractive power of the rear lens group becomes excessively large, so that spherical aberration and coma become worse.

With setting the lower limit of conditional expression (6) to 4.50, it becomes possible to excellently correct various aberrations such as spherical aberration and coma, so that the effect of the present invention can be secured. With setting the lower limit of conditional expression (6) to 5.10, it becomes possible to further excellently correct various aberrations such as spherical aberration and coma, so that the effect of the present invention can be further secured. With setting the lower limit of conditional expression (6) to 6.00, it becomes possible to further excellently correct various aberrations such as spherical aberration and coma, so that the effect of the present invention can fully be exhibited.

In a wide-angle lens according to the present embodiment, the following conditional expression (7) is preferably satisfied:

0.05<Nn−((Np1+Np2)/2)<0.30 (7)

where Nn denotes a refractive index at d-line (wavelength λ=587.6 nm) of the negative lens in the cemented lens, Np1 denotes a refractive index at d-line of the positive lens disposed to the object side in the cemented lens, and Np2 denotes a refractive index at d-line of the positive lens disposed to the image side in the cemented lens.

Conditional expression (7) defines an appropriate range of a difference between the refractive index of the negative lens in the cemented lens and an average value of refractive indices of the two positive lenses in the cemented lens. With satisfying conditional expression (7), it becomes possible to realize a wide-angle lens having high optical performance.

When the value Nn−((Np1+Np2)/2) is equal to or exceeds the upper limit of conditional expression (7), the difference between the refractive index of the negative lens in the cemented lens and the average value of refractive indices of the two positive lenses in the cemented lens becomes large, and Petzval sum does not become optimum value, so that curvature of field and astigmatism become worse.

With setting the upper limit of conditional expression (7) to 0.25, it becomes possible to excellently correct various aberrations such as curvature of field and astigmatism, so that the effect of the present invention can be secured. With setting the upper limit of conditional expression (7) to 0.20, it becomes possible to further excellently correct various aberrations such as curvature of field and astigmatism, so that the effect of the present invention can be further secured. With setting the upper limit of conditional expression (7) to 0.19, it becomes possible to further excellently correct various aberrations such as curvature of field and astigmatism, so that the effect of the present invention can fully be exhibited.

On the other hand, when the value Nn−((Np1+Np2)/2) is equal to or falls below the lower limit of conditional expression (7), the difference between the refractive index of the negative lens in the cemented lens and the average value of refractive indices of the two positive lenses in the cemented lens becomes small, so that curvature of field, coma and spherical aberration become worse.

With setting the lower limit of conditional expression (7) to 0.08, it becomes possible to excellently correct various aberrations such as curvature of field, coma and spherical aberration, so that the effect of the present invention can be secured. With setting the lower limit of conditional expression (7) to 0.10, it becomes possible to further excellently correct various aberrations such as curvature of field, coma and spherical aberration, so that the effect of the present invention can be further secured. With setting the lower limit of conditional expression (7) to 0.12, it becomes possible to further excellently correct various aberrations such as curvature of field, coma and spherical aberration, so that the effect of the present invention can fully be exhibited.

In a wide-angle lens according to the present embodiment, the sub-lens group is preferably composed of negative lenses only. With this construction, it becomes possible to make the diameter of the front lens small. Moreover, curve of distortion can be suppressed.

Each example of a wide-angle lens according to the present embodiment is explained below with reference to accompanying drawings.

### Example 1

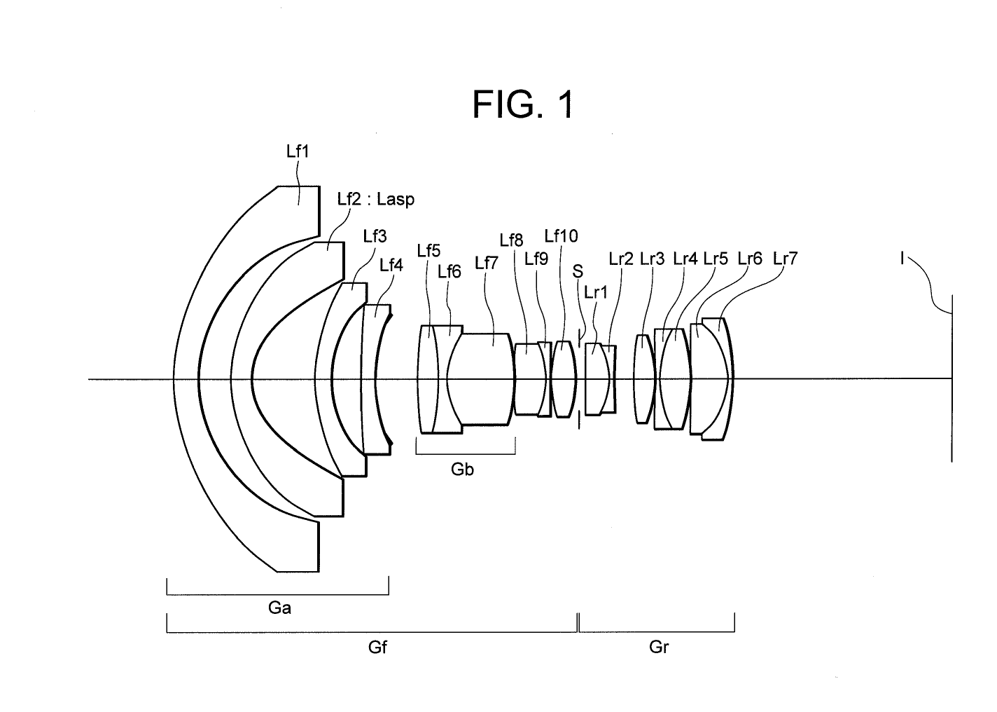

FIG. 1 is a sectional view showing a lens configuration of a wide-angle lens according to Example 1 of the present embodiment.

The wide-angle lens according to Example 1 is composed of, in order from an object side, a front lens group Gf having positive refractive power, an aperture stop S, and a rear lens group Gr having positive refractive power.

The front lens group Gf includes a sub-lens group Ga having negative refractive power. The sub-lens group Ga is composed of, in order from the most object side, a negative meniscus lens Lf1 having a convex surface facing the object side, a negative meniscus lens Lf2 (Lasp) having a convex surface facing the object side and an aspherical surface having a large aspherical amount formed on the image side lens surface, a negative meniscus lens Lf3 having a convex surface facing the object side, and a negative meniscus lens Lf4 having a convex surface facing the object side and an aspherical surface formed on the image side surface. The negative meniscus lens Lf4 is a compound type aspherical lens composed of a glass lens and a resin material.

The front lens group Gf further includes, to the image side of the sub-lens group Ga in order from the object side, a cemented positive lens Gb constructed by a double convex positive lens Lf5 cemented with a double concave negative lens Lf6 cemented with a double convex positive lens Lf7. The front lens group Gf further includes, to the image side of the cemented positive lens Gb in order from the object side, a cemented negative lens constructed by double convex positive lens Lf8 cemented with a double concave negative lens Lf9, and a double convex positive lens Lf10.

The rear lens group Gr is composed of, in order from the object side, a cemented negative lens constructed by a double convex positive lens Lr1 cemented with a double concave negative lens Lr2, a double convex positive lens Lr3, a cemented negative lens constructed by a double concave negative lens Lr4 cemented with a double convex positive lens Lr5, and a cemented negative lens constructed by a double convex positive lens Lr6 cemented with a negative meniscus lens Lr7 having a convex surface facing the image side.

An antireflection coating explained later is applied to the image side lens surface of the negative meniscus lens Lf2 in the front lens group Gf and the object side lens surface of the negative meniscus lens Lf3 in the front lens group Gf.

Various values associated with the wide-angle lens according to Example 1 are listed in Table 1.

In (Specifications), F0 denotes a focal length of the wide-angle lens, FNO denotes an f-number, ω denotes a half angle of view (unit: degree), Y denotes an image height, TL denotes a total lens length, BF denotes a back focal length, and hasp denotes a half of an effective diameter (maximum effective radius) of the aspherical negative meniscus lens having a shape whose negative refractive power is getting smaller from the center to the periphery.

In (Lens Surface Data), the left most column “i” shows the lens surface number counted in order from the object side, the second column “r” shows a radius of curvature of the lens surface, the third column “d” shows a distance to the next surface, the fourth column “nd” shows a refractive index at d-line (wavelength λ=587.6 nm), and the fifth column “νd” shows an Abbe number at d-line (wavelength λ=587.6 nm). Moreover, “OP” denotes an object plane, and “I” denotes an image plane. In the fifth column “nd”, the refractive index of the air nd=1.000000 is omitted. In the second column “r”, r=^{∞} represents a plane surface. An aspherical surface is expressed by attaching “*” to the right side of the lens surface number, and a paraxial radius of curvature is shown in the second column “r”.

In (Aspherical Surface Data), the aspherical surface is exhibited by the following expression:

X(y)=(y²/r)/[1+{1−κ×(y²/r²)}^{1/2}]+A3×|y|³+A4×y⁴+A6×y⁶+A8×y⁸+A10×y¹⁰+A12×y¹²+A14×y¹⁴+A16×y¹⁶+A18×y¹⁸

where “y” denotes a vertical height from the optical axis, X(y) denotes a sag amount which is a distance along the optical axis from the tangent surface at the vertex of the aspherical surface to the aspherical surface at the vertical height y from the optical axis, r denotes a radius of curvature of a reference sphere (paraxial radius of curvature), κ denotes a conical coefficient, and An denotes an aspherical coefficient of n-th order.

In (Aspherical Surface Data), “E−n” denotes “×10⁻ⁿ”, in which “n” is an integer, and for example “1.234E-05” denotes “1.234×10⁻⁵”.

In (Lens Group Data), a starting surface number “ST” and a focal length of each lens group are shown.

In (Values for Conditional Expressions), values for respective conditional expressions are shown.

In respective tables for various values, “mm” is generally used for the unit of length such as the focal length, the radius of curvature and the distance to the next lens surface. However, since similar optical performance can be obtained by an optical system proportionally enlarged or reduced its dimension, the unit is not necessarily to be limited to “mm”, and any other suitable unit can be used.

The explanation of reference symbols is the same in the other Examples, and duplicated explanations are omitted.

TABLE 1
(Specifications)

F0 = 17.11
FNO = 4.08
ω = 63.03°
Y = 33.00
TL = 188.30
BF = 53.036
hasp = 23.45

(Lens Surface Data)

| i | r | d | nd | νd |
|---|---|---|---|---|
| OP | ∞ | ∞ | | |
| 1) | 55.7193 | 6.0000 | 1.816000 | 46.63 |
| 2) | 35.5890 | 8.0000 | | |
| 3) | 38.4103 | 5.0000 | 1.744429 | 49.52 |
| 4)* | 16.3041 | 15.2654 | | |
| 5) | 46.4851 | 4.0000 | 1.497820 | 82.56 |
| 6) | 26.2269 | 7.1871 | | |
| 7) | 243.1206 | 3.2000 | 1.816000 | 46.63 |
| 8) | 38.0000 | 0.3000 | 1.553890 | 38.09 |
| 9)* | 47.2922 | 10.2085 | | |
| 10) | 89.3594 | 5.0000 | 1.620040 | 36.24 |
| 11) | −56.6985 | 2.0000 | 1.772500 | 49.61 |
| 12) | 20.1399 | 16.2376 | 1.620040 | 36.30 |
| 13) | −44.0814 | 0.1000 | | |
| 14) | 182.3038 | 7.7000 | 1.516800 | 64.12 |
| 15) | −18.4419 | 1.0000 | 1.755000 | 52.29 |
| 16) | 850.8298 | 0.1000 | | |
| 17) | 31.8462 | 6.0000 | 1.517420 | 52.32 |
| 18) | −28.2936 | 1.0000 | | |

| | | | |
|---|---|---|---|
| 19> | ∞ | 1.5000 | Aperture Stop S |

| | | | | |
|---|---|---|---|---|
| 20) | 747.4754 | 5.8000 | 1.516800 | 64.12 |
| 21) | −16.2847 | 1.0000 | 1.772500 | 49.61 |
| 22) | 133.1446 | 4.9671 | | |
| 23) | 79.0725 | 5.0000 | 1.516800 | 64.12 |
| 24) | −31.8944 | 0.1000 | | |
| 25) | −375.6194 | 1.0000 | 1.834810 | 42.72 |
| 26) | 26.0116 | 7.5000 | 1.497820 | 82.52 |
| 27) | −36.6478 | 0.1000 | | |
| 28) | 4349.6200 | 9.0000 | 1.497820 | 82.52 |
| 29) | −17.5712 | 1.0000 | 1.772500 | 49.61 |
| 30) | −54.0317 | 53.0362 | | |
| I | ∞ | | | |

(Aspherical Surface Data)

Surface Number: 4
κ = 0.2107
A3 = 0.00
A4 = 5.35500E−07
A6 = 2.01830E−08
A8 = −5.31700E−11
A10 = 6.83930E−14
A12 = 0.000
A14 = −0.47143E−19
A16 = −0.22240E−22
A18 = −0.55629E−25
Surface Number: 9
κ = −13.9080
A3 = 0.81216E−05
A4 = 2.85450E−05
A6 = −2.74190E−08
A8 = −1.66860E−11
A10 = 2.75060E−13
A12 = 0.14148E−14
A14 = −0.93816E−17
A16 = 0.16488E−19
A18 = 0.00

(Lens Group Data)

| Group | ST | focal length |
|---|---|---|
| Gf | 1 | 16.350 |
| Gr | 20 | 355.951 |

(Values for Conditional Expressions)

(1) |Rasp|/hasp = 0.695
(2) (Rr + Rf)/(Rr − Rf) = −0.475
(3) Ff/F0 = 0.956
(4) F0/Fb = 0.189
(5) (−Fa)/BF = 0.254
(6) Fr/F0 = 20.816
(7) Nn − ((Np1 + Np2)/2) = 0.153

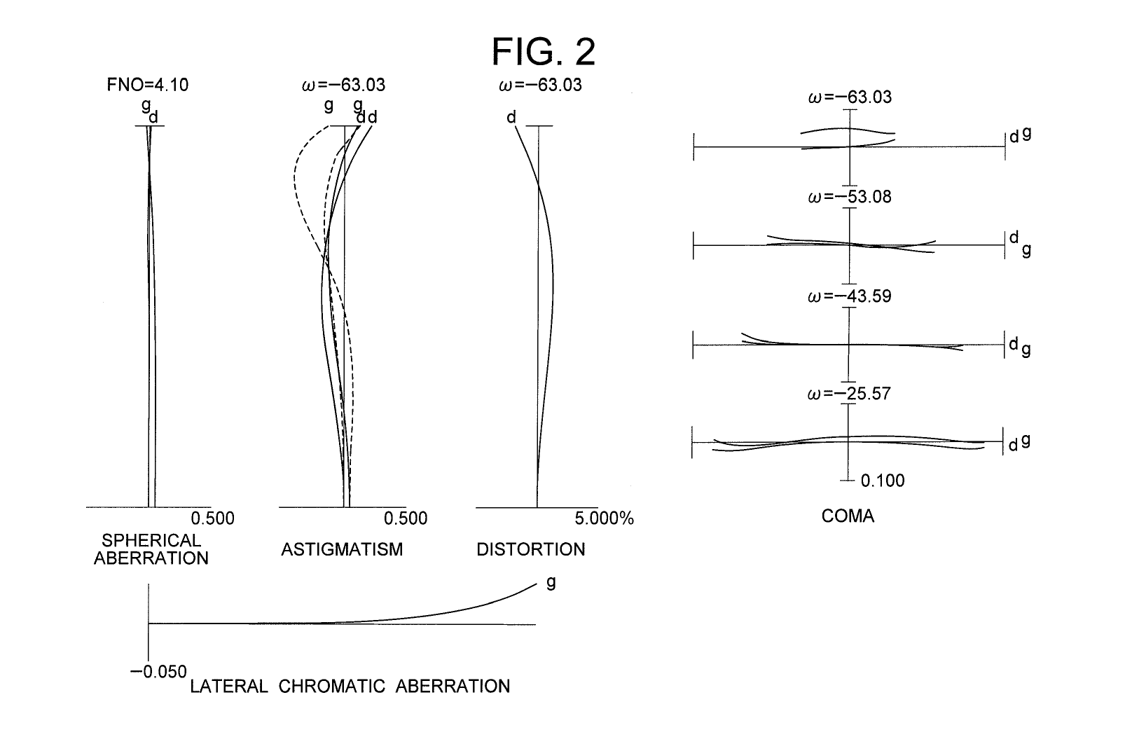

FIG. 2 shows graphs of various aberrations of the wide-angle lens according to Example 1 upon focusing on infinity.

In respective graphs, FNO denotes an f-number, and ω denotes a half angle of view (unit: degrees). In respective graphs, d denotes an aberration curve at d-line (wavelength λ=587.6 nm), and g denotes an aberration curve at g-line (wavelength λ=435.8 nm). In the graph showing astigmatism, a solid line indicates a sagittal image plane, and a broken line indicates a meridional image plane. In graphs showing coma, a solid line shows meridional coma. The above-described explanations regarding various aberration graphs are the same as the other Examples.

As is apparent from FIG. 2, the wide-angle lens according to Example 1 shows superb optical performance as a result of good corrections to various aberrations.

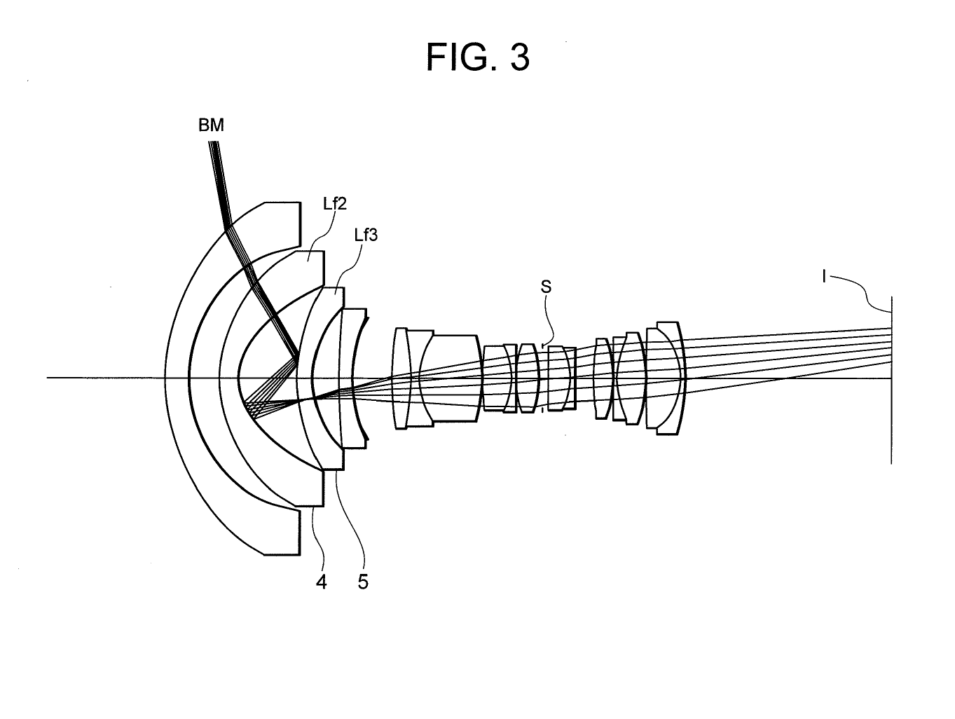

FIG. 3 is a sectional view showing the lens configuration of a wide-angle lens having similar configuration as the wide-angle lens according to Example 1 and is an explanatory view, in which light rays BM from an object generates ghost images.

As shown in FIG. 3, when light rays BM from an object are incident on the wide-angle lens, the rays are reflected by the object side lens surface (a first-ghost-generating surface whose surface number is 5) of the negative meniscus lens Lf3, and the reflected light rays are reflected again by the image side lens surface (a second-ghost-generating surface whose surface number is 4) of the negative meniscus lens Lf2 to reach the image plane I with generating ghost images. Incidentally, the first-ghost-generating surface 5 is an object side lens surface having convex shape facing the object side in the front lens group, and the second-ghost-generating surface 4 is an image side lens surface having a concave shape facing the image side in the front lens group. With applying an antireflection coating corresponding to a broad wavelength range to such lens surfaces, it becomes possible to effectively suppress ghost images and flare.

In the wide-angle lens according to Example 1, with applying an antireflection coating explained later to the image plane I side lens surface (concave lens surface facing the image plane I side) of the negative meniscus lens Lf2 in the front lens group and the object side lens surface (convex lens surface facing the object side) of the negative meniscus lens Lf3 in the front lens group, ghost images and flare can be suppressed. Incidentally, the function and the effect of the antireflection coating are the same in the following Examples, so that duplicated explanations are omitted.

### Example 2

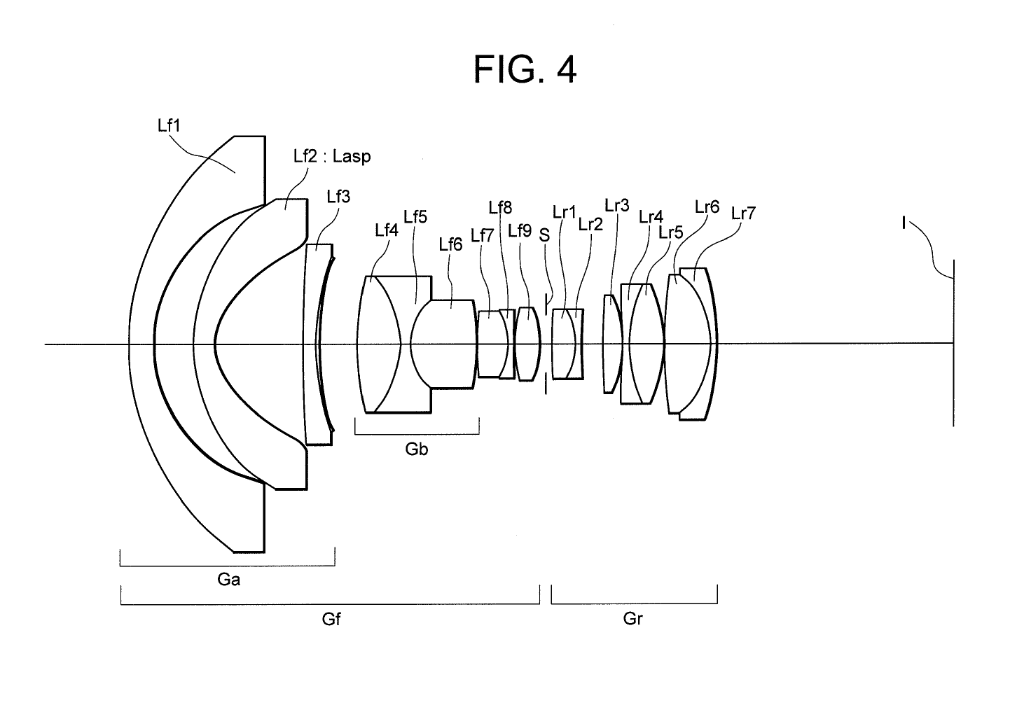

FIG. 4 is a sectional view showing a lens configuration of a wide-angle lens according to Example 2 of the present embodiment.

The wide-angle lens according to Example 2 is composed of, in order from an object side, a front lens group Gf having positive refractive power, an aperture stop S, and a rear lens group Gr having positive refractive power.

The front lens group Gf includes a sub-lens group Ga having negative refractive power. The sub-lens group Ga is composed of, in order from the most object side, a negative meniscus lens Lf1 having a convex surface facing the object side, a negative meniscus lens Lf2 (Lasp) having a convex surface facing the object side and an aspherical surface having a large aspherical amount formed on the image side surface, and a negative meniscus lens Lf3 having a convex surface facing the object side and an aspherical surface formed on the image side surface. The negative meniscus lens Lf3 is a compound type aspherical lens composed of a glass lens and a resin material.

The front lens group Gf further includes, to the image side of the sub-lens group Ga in order from the object side, a cemented positive lens Gb constructed by a double convex positive lens Lf4 cemented with a double concave negative lens Lf5 cemented with a double convex positive lens Lf6. The front lens group Gf further includes, to the image side of the cemented positive lens Gb in order from the object side, a cemented negative lens constructed by double convex positive lens Lf7 cemented with a double concave negative lens Lf8, and a double convex positive lens Lf9.

The rear lens group Gr is composed of, in order from the object side, a cemented negative lens constructed by a double convex positive lens Lr1 cemented with a double concave negative lens Lr2, a double convex positive lens Lr3, a cemented negative lens constructed by a double concave negative lens Lr4 cemented with a double convex positive lens Lr5, and a cemented positive lens constructed by a double convex positive lens Lr6 cemented with a negative meniscus lens Lr7 having a convex surface facing the image side.

An antireflection coating explained later is applied to the image side lens surface of the negative meniscus lens Lf1 in the front lens group Gf and the object side lens surface of the negative meniscus lens Lf2 in the front lens group Gf.

Various values associated with the wide-angle lens according to Example 2 are listed in Table 2.

TABLE 2
(Specifications)

F0 = 10.3
FNO = 4.17
ω = 64.84°
Y = 21.6
TL = 132.78
BF = 38.10
hasp = 16.06

(Lens Surface Data)

| i | r | d | nd | νd |
|---|---|---|---|---|
| OP | ∞ | ∞ | | |
| 1) | 42.3831 | 4.0000 | 1.816000 | 46.63 |
| 2) | 23.2938 | 6.3000 | | |
| 3) | 27.5491 | 3.5000 | 1.729030 | 54.04 |
| 4)* | 9.7702 | 14.2885 | | |
| 5) | 273.4999 | 2.0000 | 1.755000 | 52.29 |
| 6) | 40.0000 | 0.5000 | 1.553890 | 38.09 |
| 7)* | 55.6948 | 6.1625 | | |
| 8) | 49.1830 | 7.0000 | 1.672700 | 32.11 |
| 9) | −16.1713 | 1.5000 | 1.816000 | 46.63 |
| 10) | 9.7963 | 10.7268 | 1.620040 | 36.30 |
| 11) | −36.6819 | 0.1000 | | |
| 12) | 533.9192 | 5.0000 | 1.516800 | 64.12 |
| 13) | −10.9681 | 1.0000 | 1.755000 | 52.29 |
| 14) | 233.8827 | 0.1000 | | |
| 15) | 26.0608 | 4.0000 | 1.517420 | 52.32 |
| 16) | −15.6077 | 1.0000 | | |

| | | | |
|---|---|---|---|
| 17> | ∞ | 1.0000 | Aperture Stop S |

| | | | | |
|---|---|---|---|---|
| 18) | 103.7491 | 3.8000 | 1.516800 | 64.12 |
| 19) | −11.1953 | 1.0000 | 1.772500 | 49.61 |
| 20) | 171.1107 | 3.5000 | | |
| 21) | 204.9527 | 3.0000 | 1.516800 | 64.12 |
| 22) | −20.2930 | 0.1000 | | |
| 23) | −82.6214 | 1.0000 | 1.834810 | 42.72 |
| 24) | 22.2173 | 5.5000 | 1.497820 | 82.52 |
| 25) | −24.2790 | 0.1000 | | |
| 26) | 84.6349 | 7.5000 | 1.497820 | 82.52 |
| 27) | −15.1083 | 1.0000 | 1.772500 | 49.61 |
| 28) | −38.2138 | 38.0998 | | |
| I | ∞ | | | |

(Aspherical Surface Data)

Surface Number: 4
κ = 0.1747
A3 = 0.00
A4 = −5.40210E−06
A6 = 3.09140E−08
A8 = −1.36590E−10
A10 = −3.34770E−13
A12 = −0.37424E−15
A14 = −0.19508E−18
A16 = −0.17694E−19
A18 = −0.21704E−22
Surface Number: 7
κ = −13.1668
A3 = 0.00
A4 = 2.72000E−05
A6 = −5.96150E−08
A8 = −2.51320E−11
A10 = 4.73940E−13
A12 = 0.20073E−14
A14 = −0.18435E−16
A16 = 0.60550E−20
A18 = 0.37962E−21

(Lens Group Data)

| Group | ST | focal length |
|---|---|---|
| Gf | 1 | 17.872 |
| Gr | 18 | 69.147 |

(Values for Conditional Expressions)

(1) |Rasp|/hasp = 0.608
(2) (Rr + Rf)/(Rr − Rf) = −0.246
(3) Ff/F0 = 1.735
(4) F0/Fb = 0.0404
(5) (−Fa)/BF = 0.301
(6) Fr/F0 = 6.714
(7) Nn − ((Np1 + Np2)/2) = 0.168

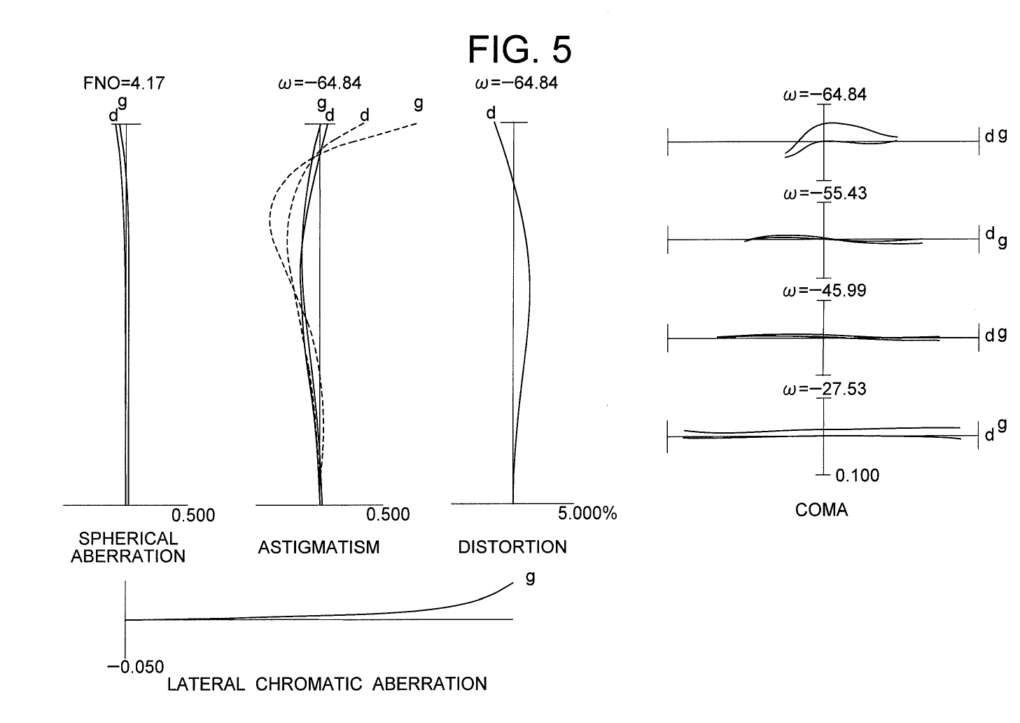

FIG. 5 shows graphs of various aberrations of the wide-angle lens according to Example 2 upon focusing on infinity.

As is apparent from FIG. 5, the wide-angle lens according to Example 2 shows superb optical performance as a result of good corrections to various aberrations.

### Example 3

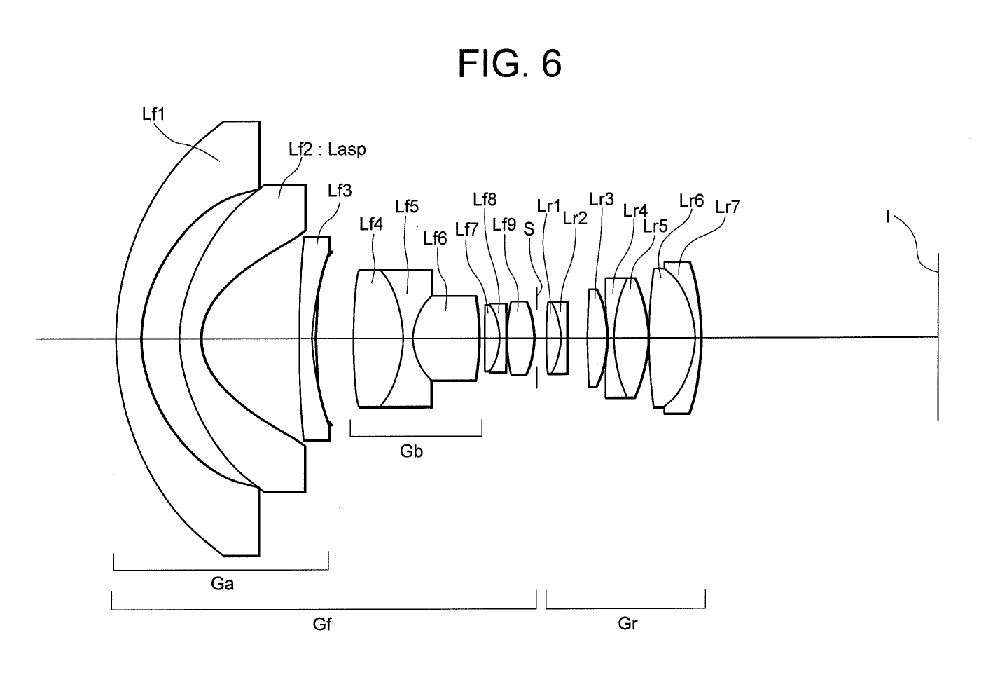

FIG. 6 is a sectional view showing a lens configuration of a wide-angle lens according to Example 3 of the present embodiment.

The wide-angle lens according to Example 3 is composed of, in order from an object side, a front lens group Gf having positive refractive power, an aperture stop S, and a rear lens group Gr having positive refractive power.

The front lens group Gf includes a sub-lens group Ga having negative refractive power. The sub-lens group Ga is composed of, in order from the most object side, a negative meniscus lens Lf1 having a convex surface facing the object side, a negative meniscus lens Lf2 (Lasp) having a convex surface facing the object side and an aspherical surface having a large aspherical amount formed on the image side surface, and a negative meniscus lens Lf3 having a convex surface facing the object side and an aspherical surface formed on the image side surface. The negative meniscus lens Lf3 is a compound type aspherical lens composed of a glass lens and a resin material.

The front lens group Gf further includes, to the image side of the sub-lens group Ga in order from the object side, a cemented negative lens Gb constructed by a double convex positive lens Lf4 cemented with a double concave negative lens Lf5 cemented with a double convex positive lens Lf6, a cemented negative lens constructed by double convex positive lens Lf7 cemented with a double concave negative lens Lf8, and a double convex positive lens Lf9.

The rear lens group Gr is composed of, in order from the object side, a cemented negative lens constructed by a double convex positive lens Lr1 cemented with a double concave negative lens Lr2, a double convex positive lens Lr3, a cemented negative lens constructed by a double concave negative lens Lr4 cemented with a double convex positive lens Lr5, and a cemented positive lens constructed by a double convex positive lens Lr6 cemented with a negative meniscus lens Lr7 having a convex surface facing the image side.

An antireflection coating explained later is applied to the image side lens surface of the negative meniscus lens Lf1 in the front lens group Gf and the object side lens surface of the negative meniscus lens Lf2 in the front lens group Gf.

Various values associated with the wide-angle lens according to Example 3 are listed in Table 3.

TABLE 3
(Specifications)

F0 = 10.3
FNO = 4.08
ω = 64.85°
Y = 21.6
TL = 132.47
BF = 38.10
hasp = 16.57

(Lens Surface Data)

| i | r | d | nd | νd |
|---|---|---|---|---|
| OP | ∞ | ∞ | | |
| 1) | 45.0887 | 4.0000 | 1.816000 | 46.63 |
| 2) | 25.2008 | 6.3000 | | |
| 3) | 29.6192 | 3.5000 | 1.729030 | 54.04 |
| 4)* | 9.8560 | 15.8448 | | |
| 5) | 236.1722 | 2.0000 | 1.497820 | 82.56 |
| 6) | 40.0000 | 0.5000 | 1.553890 | 38.09 |
| 7)* | 60.5981 | 6.1625 | | |
| 8) | 86.9847 | 8.0000 | 1.717360 | 29.52 |
| 9) | −19.2982 | 1.5000 | 1.816000 | 46.63 |
| 10) | 9.6120 | 10.7268 | 1.620040 | 36.30 |
| 11) | −41.2930 | 0.8000 | | |
| 12) | 283.9959 | 2.5000 | 1.516800 | 64.12 |
| 13) | −10.5331 | 1.0000 | 1.755000 | 52.29 |
| 14) | 256.1395 | 0.1000 | | |
| 15) | 26.8460 | 4.4394 | 1.517420 | 52.32 |
| 16) | −14.9478 | 0.5000 | | |

| | | | |
|---|---|---|---|
| 17> | ∞ | 1.5000 | Aperture Stop S |

| | | | | |
|---|---|---|---|---|
| 18) | 102.3075 | 2.5000 | 1.516800 | 64.12 |
| 19) | −11.1953 | 0.8000 | 1.772500 | 49.61 |
| 20) | 155.7889 | 3.5000 | | |
| 21) | 324.2212 | 3.0000 | 1.516800 | 64.12 |
| 22) | −19.9279 | 0.1000 | | |
| 23) | −80.8508 | 1.0000 | 1.834810 | 42.72 |
| 24) | 22.9204 | 5.5000 | 1.497820 | 82.52 |
| 25) | −23.3970 | 0.1000 | | |
| 26) | 103.6067 | 7.5000 | 1.497820 | 82.52 |
| 27) | −15.1862 | 1.0000 | 1.772500 | 49.61 |
| 28) | −38.2138 | 38.0981 | | |
| I | ∞ | | | |

(Aspherical Surface Data)

Surface Number: 4
κ = 0.1762
A3 = 0.00
A4 = −6.35770E−06
A6 = 4.44690E−08
A8 = −7.73560E−11
A10 = −1.74660E−13
A12 = −0.21396E−17
A14 = 0.62903E−18
A16 = −0.15122E−19
A18 = −0.21704E−22
Surface Number: 7
κ = −10.5548
A3 = 0.00
A4 = 2.43610E−05
A6 = −4.61180E−08
A8 = 3.69100E−11
A10 = 6.01950E−13
A12 = 0.19444E−14
A14 = −0.23879E−16
A16 = −0.22081E−19
A18 = 0.48172E−21

(Lens Group Data)

| Group | ST | focal length |
|---|---|---|
| Gf | 1 | 16.756 |
| Gr | 18 | 72.338 |

(Values for Conditional Expressions)

(1) |Rasp|/hasp = 0.595
(2) (Rr + Rf)/(Rr − Rf) = −0.335
(3) Ff/F0 = 1.627
(4) F0/Fb = −0.00212
(5) (−Fa)/BF = 0.352
(6) Fr/F0 = 7.023
(7) Nn − ((Np1 + Np2)/2) = 0.147

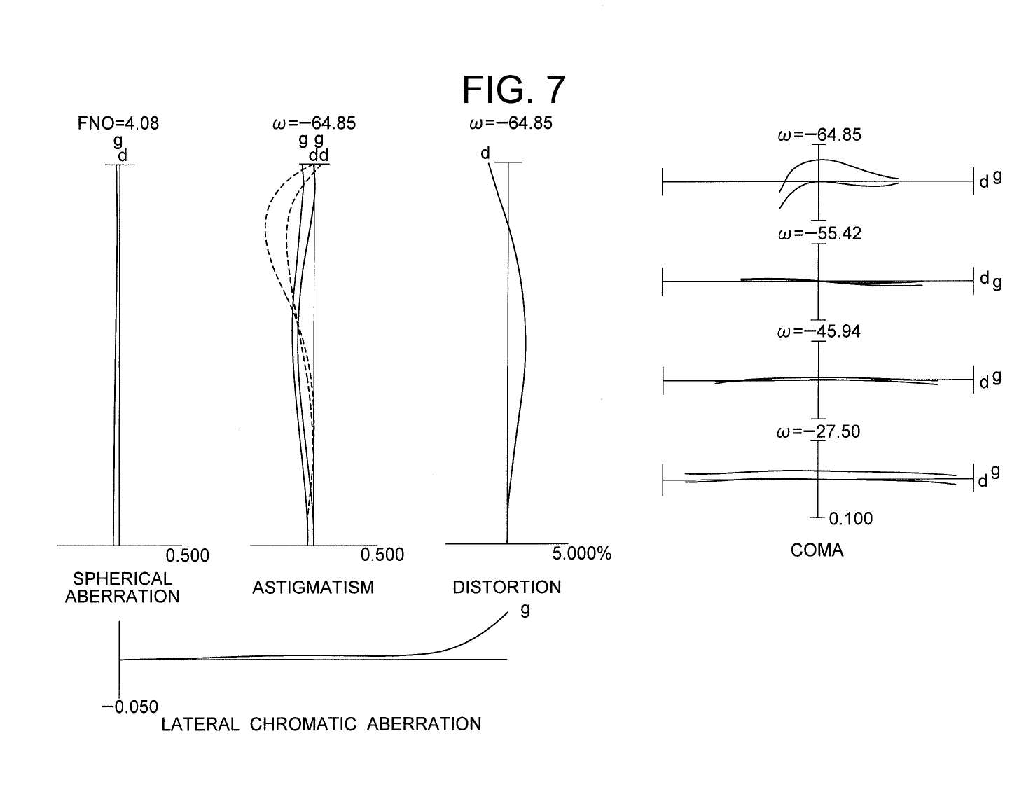

FIG. 7 shows graphs of various aberrations of the wide-angle lens according to Example 3 upon focusing on infinity.

As is apparent from FIG. 7, the wide-angle lens according to Example 3 shows superb optical performance as a result of good corrections to various aberrations.

Then, an antireflection coating used in the wide-angle lenses according to Example 1 through 3 of the present embodiment is explained.

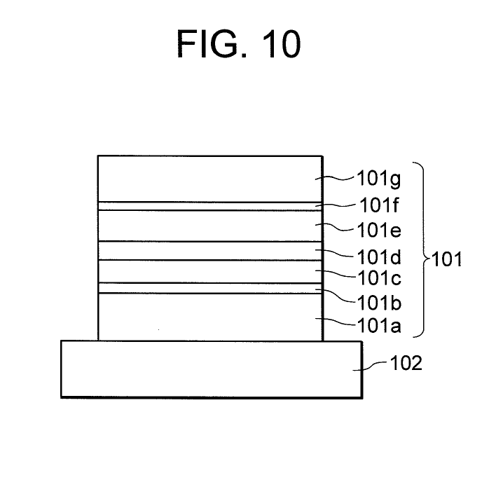

FIG. 10 is an explanatory view showing a configuration of an antireflection coating used in the wide-angle lens according to the present embodiment. The antireflection coating 101 is composed of seven layers and is formed on an optical surface of an optical member 102 such as a lens. A first layer 101a is formed with aluminum oxide by means of a vacuum evaporation method. On the first layer 101a, a second layer 101b formed with mixture of titanium oxide and zirconium oxide by means of a vacuum evaporation method is formed. Moreover, on the second layer 101b, a third layer 101c formed with aluminum oxide by means of vacuum evaporation method is formed. Moreover, on the third layer 101c, a fourth layer 101d formed with a mixture of titanium oxide and zirconium oxide by means of a vacuum evaporation method is formed. Furthermore, on the fourth layer 101d, a fifth layer 101e formed with aluminum oxide by means of vacuum evaporation method is formed. On the fifth layer 101e, a sixth layer 101f formed with mixture of titanium oxide and zirconium oxide by means of a vacuum evaporation method is formed.

Then, on the sixth layer 101f formed in this manner, a seventh layer 101g formed with a mixture of silica and magnesium fluoride is formed by means of a wet process to form the antireflection coating according to the present embodiment. In order to form the seventh layer 101g, a sol-gel process, which is a kind of wet process, is used. The sol-gel process is a method for forming a film such that an optical-thin-film-material sol is applied to an optical surface of an optical member, after accumulating the gel film it is dipped into a liquid, and the liquid is vaporized and dried with controlling temperature and pressure of the liquid over the critical state to form the film. Incidentally, a wet-process is not necessarily limited to the sol-gel process, a method that a solid film is obtained without undergoing through gel state may be used.

In this manner, the first layer 101a through the sixth layer 101f are formed by electron beam evaporation, which is a dry process, and the seventh layer 101g, which is the uppermost layer, is formed by a following wet-process using sol liquid prepared by a hydrofluoric acid/magnesium acetate method. At first, an aluminum oxide layer, which becomes a first layer 101a, a mixture of titanium oxide and zirconium oxide layer, which becomes a second layer 101b, an aluminum oxide layer, which becomes a third layer 101c, a mixture of titanium oxide and zirconium oxide layer, which becomes a fourth layer 101d, an aluminum oxide layer, which becomes a fifth layer 101e, and a mixture of titanium oxide and zirconium oxide layer, which becomes a sixth layer 101f are formed on a film-forming surface (the above-mentioned optical surface of the optical member 102) in this order by a vacuum evaporation equipment. Then, after being took out from the vacuum evaporation equipment, the optical member 102 is applied with a sol liquid prepared by the hydrofluoric acid/magnesium acetate method added by silicon-alkoxide by means of a spin coat method, so that a layer formed by a mixture of silica and magnesium fluoride, which becomes a seventh layer 101g, is formed. A reaction formula prepared by the hydrofluoric acid/magnesium acetate method is shown by expression (8):

2HF+Mg(CH3COO)2→MgF2+2CH3COOH (8).

The sol liquid is used for forming the film after mixing ingredients with undergoing high temperature, high pressure maturing process at 140° C., 24 hours by means of an autoclave. After completion of forming the seventh layer 101g, the optical member 102 is processed with heating treatment at 160° C. in atmospheric pressure for 1 hour to be completed. With using such a sol gel method, atoms or molecules are built up from several to several tens to become particles of several nanometers to several tens of nanometers, and several these particles are built up to form secondary particles. As a result, the secondary particles are piled up to form the seventh layer 101g.

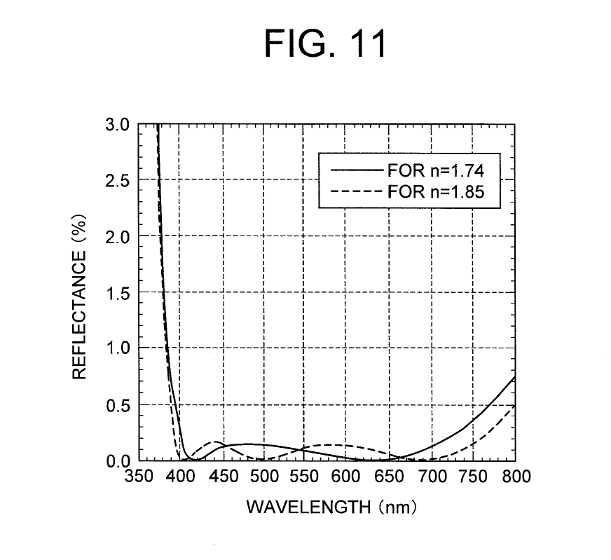

Optical performance of the optical member including the thus-formed antireflection coating 101 will hereinafter be described by using spectral characteristics shown in FIG. 11. FIG. 11 shows the spectral characteristics when the light beams are vertically incident on the optical member in which the optical film thickness of each of the layers of the antireflection coating 101 is designed with the reference wavelength λ set to 550 nm in Table 4. In Table 4, Al203 is expressed as the aluminum oxide, ZrO2+TiO2 is expressed as the mixture of titanium oxide and zirconium oxide and MgF2+SiO2 is expressed as the mixture of magnesium fluoride and silica. Table 4 shows respective optical film thicknesses of the layers 101a through 101g of the antireflection coating 101, which are obtained under such conditions that λ denotes a reference wavelength and the refractive index of the substrate is set to 1.62, 1.74 and 1.85. Incidentally, in the Table 4, even the optical member including the antireflection coating 101, in which each optical film thickness is designed with the reference wavelength λ set to the d-line (wavelength 587.6 nm), has substantially the same spectral characteristics as in the case where the reference wavelength λ shown in FIG. 11 is 550 nm in a way that affects substantially none of the spectral characteristics thereof.

TABLE 4

| layer | material | n | thicknesses of layers | | |
|---|---|---|---|---|---|
| | medium air | 1 | | | |
| 7 | MgF2 + SiO2 | 1.26 | 0.268λ | 0.271λ | 0.269λ |
| 6 | ZrO2 + TiO2 | 2.12 | 0.057λ | 0.054λ | 0.059λ |
| 5 | Al2O3 | 1.65 | 0.171λ | 0.178λ | 0.162λ |
| 4 | ZrO2 + TiO2 | 2.12 | 0.127λ | 0.13λ | 0.158λ |
| 3 | Al2O3 | 1.65 | 0.122λ | 0.107λ | 0.08λ |
| 2 | ZrO2 + TiO2 | 2.12 | 0.059λ | 0.075λ | 0.105λ |
| 1 | Al2O3 | 1.65 | 0.257λ | 0.03λ | 0.03λ |

| | | | |
|---|---|---|---|
| n (substrate) | 1.62 | 1.74 | 1.85 |

It is understood from FIG. 11 that the optical member including the antireflection coating 101 designed with the reference wavelength λ set to 550 nm can restrain the reflectance down to 0.2% or less over the entire range in which the wavelengths of the light beams are 420 nm through 720 nm.

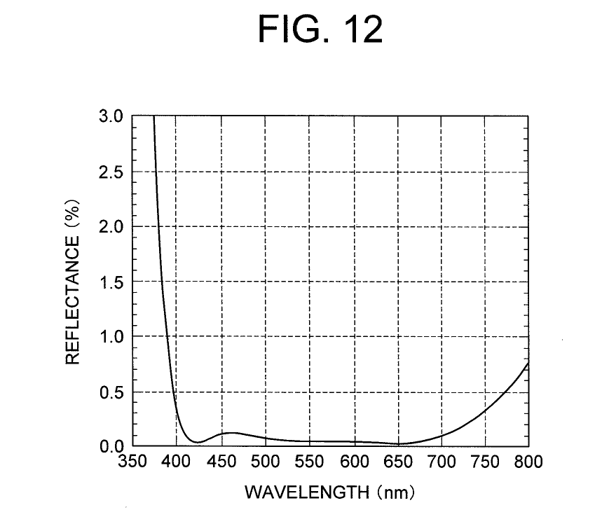

Then, a modified example of the antireflection coating will be explained. The antireflection coating is a 5-layered film, and the optical film thickness of each layer with respect to the reference wavelength λ is designed under conditions shown in the following Table 5. In this modified example, the formation of the fifth layer involves using the sol-gel process described above. Note that in the Table 5, even the optical member including the antireflection coating, in which each optical film thickness is designed with the reference wavelength λ set to the d-line (wavelength 587.6 nm), has substantially the same spectral characteristics as the spectral characteristics shown in FIG. 12 in a way that affects substantially none of the spectral characteristics thereof.

TABLE 5

| | | | |
|---|---|---|---|
| layer | material | n | thicknesses of layers |

| | | | | |
|---|---|---|---|---|
| | medium air | 1 | | |
| 5 | MgF2 + SiO2 | 1.26 | 0.275λ | 0.269λ |
| 4 | ZrO2 + TiO2 | 2.12 | 0.045λ | 0.043λ |
| 3 | Al2O3 | 1.65 | 0.212λ | 0.217λ |
| 2 | ZrO2 + TiO2 | 2.12 | 0.077λ | 0.066λ |
| 1 | Al2O3 | 1.65 | 0.288λ | 0.290λ |

| | | |
|---|---|---|
| n (substrate) | 1.46 | 1.52 |

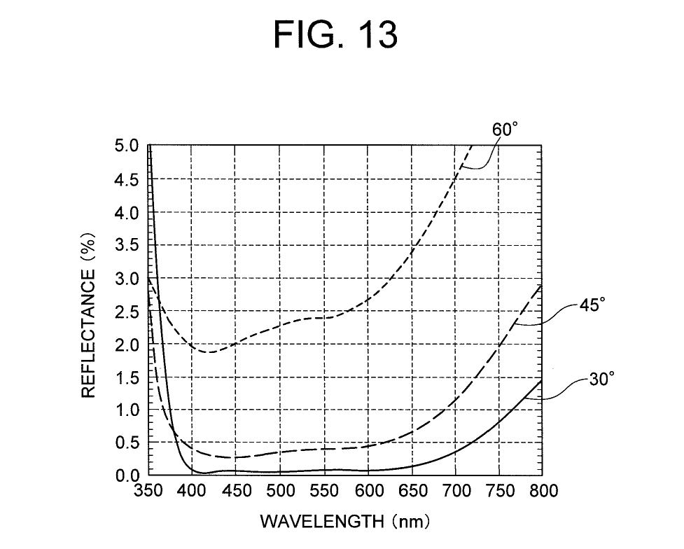

FIG. 12 shows the spectral characteristics when the light beams are vertically incident on the optical member in which the optical film thickness of each of the layers is designed, with the substrate refractive index set to 1.52 and the reference wavelength λ set to 550 nm in the Table 5. It is understood from FIG. 12 that the antireflection coating in the modified example can restrain the reflectance down to 0.2% or less over the entire range in which the wavelengths of the light beams are 420 nm-720 nm. FIG. 13 shows the spectral characteristics in such a case that the incident angles of the light beams upon the optical member having the spectral characteristics shown in FIG. 12 are 30 degrees, 45 degrees and 60 degrees, respectively.

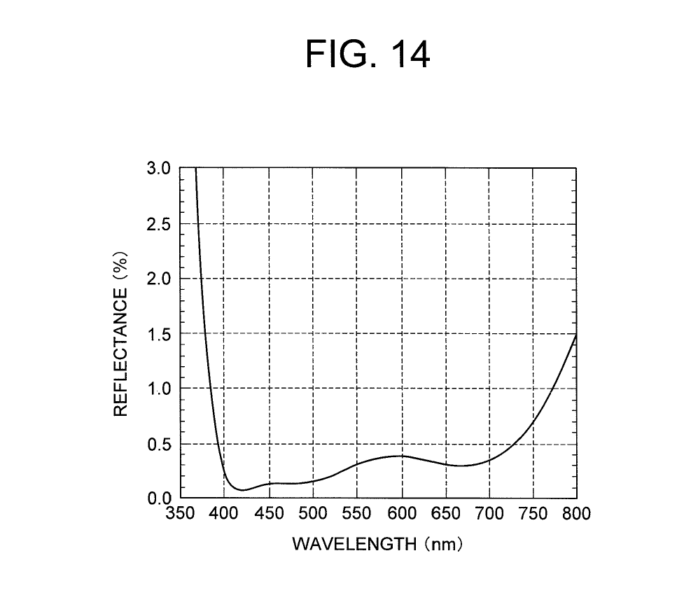

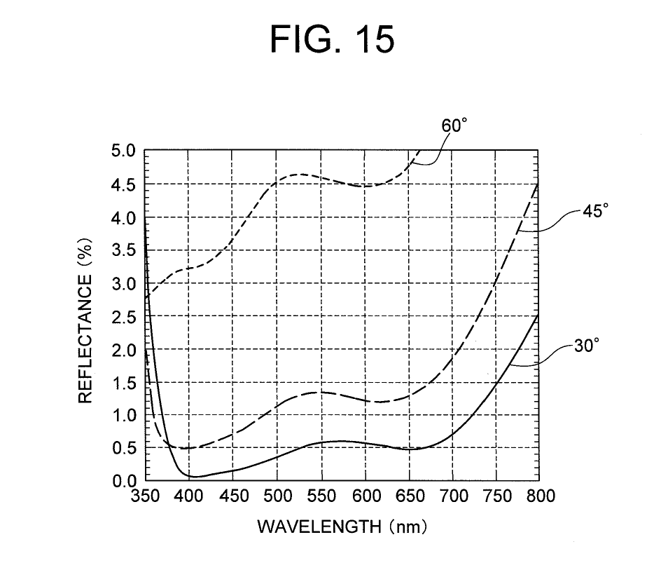

Furthermore, FIG. 14 shows one example of the antireflection coating grown by only the dry process such as the conventional vacuum evaporation method by way of a comparison. FIG. 14 shows the spectral characteristics when the light beams are vertically incident on the optical member in which to design the antireflection coating structured under the conditions shown in the following Table 6, with the substrate refractive index set to 1.52. Moreover, FIG. 15 shows the spectral characteristics in such a case that the incident angles of the light beams upon the optical member having the spectral characteristics shown in FIG. 14 are 30 degrees, 45 degrees and 60 degrees, respectively.

TABLE 6

| layer | material | n | thicknesses of layers |
|---|---|---|---|
| | medium air | 1 | |
| 7 | MgF2 | 1.39 | 0.243λ |
| 6 | ZrO2 + TiO2 | 2.12 | 0.119λ |
| 5 | Al2O3 | 1.65 | 0.057λ |
| 4 | ZrO2 + TiO2 | 2.12 | 0.220λ |
| 3 | Al2O3 | 1.65 | 0.064λ |
| 2 | ZrO2 + TiO2 | 2.12 | 0.057λ |
| 1 | Al2O3 | 1.65 | 0.193λ |

| | |
|---|---|
| refractive index of substrate | 1.52 |

To compare the spectral characteristics of the optical member including the antireflection coating according to the present embodiment illustrated in FIGS. 12 and 13 with the spectral characteristics in the conventional examples shown in FIGS. 14 and 15, it is well understood that the present antireflection coating has the much lower reflectance at any incident angles and, besides, has the low reflectance in the broader band.

Then, an example of applying the antireflection coating shown in Tables 4 and 5 to Examples 1 through Example 3 of the present embodiment discussed above is explained.

In the wide-angle lens according to Example 1, as shown in the Table 1, the refractive index nd of the negative meniscus lens Lf2 is 1.744429 (nd=1.744429), and the refractive index nd of the negative meniscus lens Lf3 is 1.497820 (nd=1.497820), whereby it is feasible to reduce the reflected light from each lens surface and to reduce ghost images and flare as well by applying the antireflection coating corresponding to 1.74 as the substrate refractive index to the image side lens surface of the negative meniscus lens Lf2 and applying the antireflection coating corresponding to 1.46 as the substrate refractive index to the object side lens surface of the negative meniscus lens Lf3.

In the wide-angle lens according to Example 2, as shown in the Table 2, the refractive index nd of the negative meniscus lens Lf1 is 1.816000 (nd=1.816000), and the refractive index nd of the negative meniscus lens Lf2 is 1.729030 (nd=1.729030), whereby it is feasible to reduce the reflected light from each lens surface and to reduce ghost images and flare as well by applying the antireflection coating corresponding to 1.85 as the substrate refractive index to the image side lens surface of the negative meniscus lens Lf1 and applying the antireflection coating corresponding to 1.74 as the substrate refractive index to the object side lens surface of the negative meniscus lens Lf2.

In the wide-angle lens according to Example 3, as shown in the Table 3, the refractive index nd of the negative meniscus lens Lf1 is 1.816000 (nd=1.816000), and the refractive index nd of the negative meniscus lens Lf2 is 1.729030 (nd=1.729030), whereby it is feasible to reduce the reflected light from each lens surface and to reduce ghost images and flare as well by applying the antireflection coating corresponding to 1.85 as the substrate refractive index to the image side lens surface of the negative meniscus lens Lf1 and applying the antireflection coating corresponding to 1.74 as the substrate refractive index to the object side lens surface of the negative meniscus lens Lf2.

Incidentally, the antireflection coating 101 can be applied to a plane parallel optical surface and to an optical surface of a lens formed by a curved shape.

As described above, each Example according to the present embodiment makes it possible to realize a wide-angle lens having an angle of view 2ω of 129.7 degrees or more, an f-number of about 4, and a small diameter of the front lens, being compact with high optical performance as a result of excellently correcting spherical aberration, curvature of field astigmatism, and coma and suppressing ghost images and flare.

Incidentally, the following description may suitably be applied within limits that do not deteriorate optical performance.

Although a wide-angle lens with a two-lens-group configuration is shown as each Example of the present application, a lens-group configuration according to the present application is not limited to this, other lens-group configurations such as a three-lens-group configuration is possible. Specifically, a lens configuration that a lens or a lens group is added to the most object side or image side of the wide-angle lens according to the present application is possible. Incidentally, a lens group is a portion that includes at least one lens and is separated by air spaces.

In a wide-angle lens according to the present application, in order to carry out focusing from an infinitely distant object to a close object, a portion of a lens group, a lens group, or a plurality of lens groups may be moved along the optical axis as a focusing lens group. Moreover, such a focusing lens group is suitable for auto focusing, and is suitable for being driven by a motor for auto focusing such as an ultrasonic motor.

In a wide-angle lens according to the present application, a lens group or a portion of a lens group may be shifted in a direction including a component perpendicular to the optical axis as a vibration reduction lens group, or tilted (swayed) in a direction including the optical axis for correcting an image blur caused by a camera shake. In a wide-angle lens according to the present application, it is particularly preferable that at least a portion of the rear lens group is used as a vibration reduction lens group.

A lens surface of a lens composing a wide-angle lens according to the present application may be a spherical surface, a plane surface, or an aspherical surface. When a lens surface is a spherical surface or a plane surface, lens processing, assembling and adjustment become easy, and deterioration in optical performance caused by lens processing, assembling and adjustment errors can be prevented, so that it is preferable. Moreover, even if the surface is shifted, deterioration in optical performance is little, so that it is preferable. When a lens surface is an aspherical surface, the aspherical surface may be fabricated by a fine grinding process, a glass molding process that a glass material is formed into an aspherical shape by a mold, or a compound type process that a resin material is formed into an aspherical shape on a glass lens surface. A lens surface may be a diffractive optical surface, and a lens may be a graded-index type lens (GRIN lens) or a plastic lens.

In a wide-angle lens according to the present application, although an aperture stop is preferably provided between the front lens group and the rear lens group, the function may be substituted by a lens frame without disposing a member as an aperture stop.

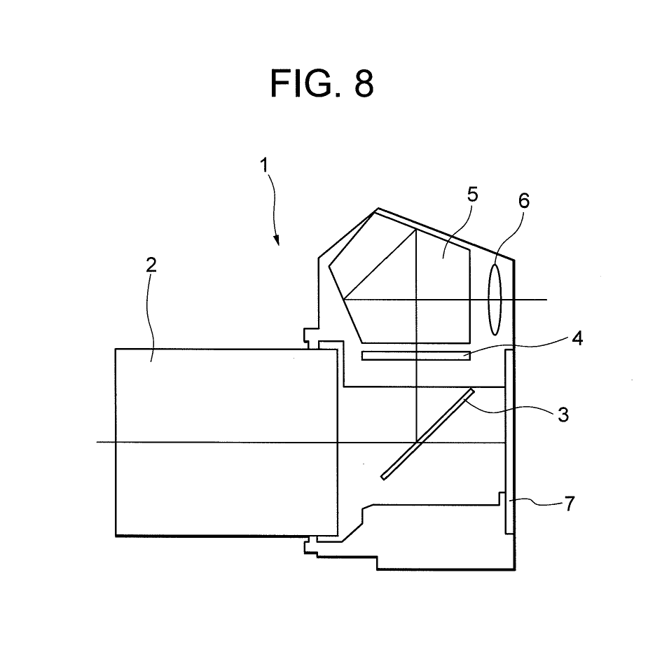

Then, an imaging apparatus equipped with a wide-angle lens according to the present application is explained with reference to a drawing. FIG. 8 is a diagram showing a construction of an imaging apparatus (a camera) equipped with a wide-angle lens according to Example 1 of the present application.

As shown in FIG. 8, the camera 1 is a single lens reflex digital camera equipped with the wide-angle lens according to Example 1 as an imaging lens 2.

In the camera 1, light rays coming out from an object (not shown) are converged by the imaging lens 2, reflected by a quick return mirror 3, and focused on a focusing screen 4. The light rays focused on the focusing screen 4 are reflected a plurality of times in a pentagonal roof prism 5, and led to an eyepiece 6. Accordingly, a photographer can observe the object image as an erected image through an eyepiece 6.

When the photographer presses an unillustrated shutter-release button all the way down, the quick return mirror 3 is retracted from the optical path, the light rays from the object converged by the imaging lens 2 are formed an image of the object on an imaging device 7. Accordingly, light rays from the object are captured by the imaging device 7 and the photographed image is stored in an unillustrated memory. In this manner, the photographer can take an image of the object by the camera 1.

Here, the wide-angle lens according to Example 1 installed in the camera 1 as an imaging lens 2 makes it possible to realize a wide-angle lens having fewer amounts of curvature of field, astigmatism and coma by the characteristic lens configuration. Accordingly, the camera 1 can realize a slim type imaging apparatus capable of taking a wide-angle picture with fewer amounts of curvature of field, astigmatism and coma.

Although an example that the wide-angle lens according to Example 1 is installed as an imaging lens 2 to construct a camera 1 is shown above, it is needless to say that a camera equipped with the wide-angle lens according to any one of Examples 2 and 3 can perform the same effect as the camera 1. Moreover, when the wide-angle lens according to any one of Examples 1 through 3 is installed in a camera having no quick return mirror 3, the same effect can be obtained.

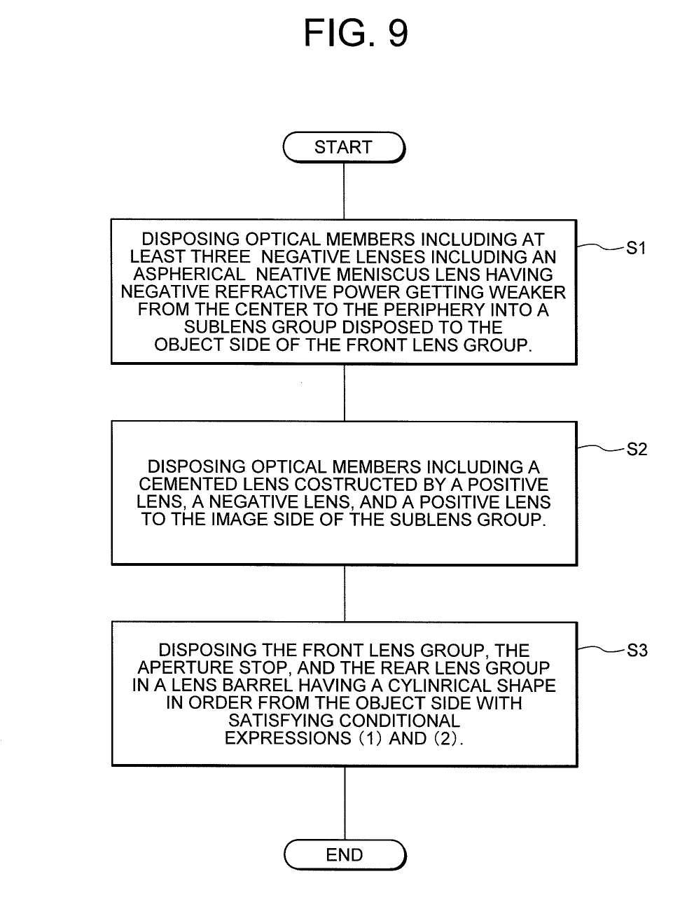

Then, an outline of a method for manufacturing a wide-angle lens according to the present embodiment is explained below with reference to FIG. 9. FIG. 9 is a flowchart showing a method for manufacturing a wide-angle lens according to the present embodiment.

The method for manufacturing a wide-angle lens according to the present embodiment is a method for manufacturing a wide-angle lens including a front lens group disposed to an object side of an aperture stop, and a rear lens group disposed to an image side of the aperture stop, and includes the following steps S1 through S3 shown in FIG. 9.

Step S1: disposing optical members including at least three negative lenses including an aspherical negative meniscus lens having a shape that negative refractive power is getting weaker from the center to the periphery into the object side sub-lens group in the front lens group.

Step S2: disposing optical members including a cemented lens constructed by a positive lens, a negative lens and a positive lens to the image side of the sub-lens group.

Step S3: disposing the front lens group, the aperture stop, and the rear lens group into a lens barrel having a cylindrical shape in order from the object side with satisfying conditional expressions (1) and (2):

0.30<|Rasp|/hasp<0.90 (1)

−1.00<(Rr+Rf)/(Rr−Rf)<0.00 (2)

where Rasp denotes a paraxial radius of curvature of an aspherical surface of the aspherical negative meniscus lens having the shape, hasp denotes a half of an effective diameter (maximum effective radius) of the aspherical negative meniscus lens having the shape, Rr denotes a radius of curvature of the image side surface of the negative lens in the cemented lens, and Rf denotes a radius of curvature of the object side surface of the negative lens in the cemented lens.

A method for manufacturing a wide-angle lens according to the present application makes it possible to manufacture a wide-angle lens having a large angle of view and excellent optical performance with further suppressing ghost images and flare.

Above-described each example only shows a specific example for the purpose of better understanding of the present invention. Accordingly, it is needless to say that the invention in its broader aspect is not limited to the specific details and representative devices shown and described herein.

What is claimed is:

1. A wide-angle lens comprising:
a front lens group disposed to an object side of an aperture stop; and
a rear lens group disposed to an image side of the aperture stop;
the front lens group including a sub-lens group having negative refractive power,
the sub-lens group including, in order from the most object side, at least three negative lenses,
at least one of the three negative lens being an aspherical negative meniscus lens,
the aspherical negative meniscus lens having a shape that negative refractive power is getting smaller from the center to the periphery,
a cemented lens constructed by a positive lens cemented with a negative lens cemented with a positive lens being disposed to the image side of the sub-lens group, and
the following conditional expressions being satisfied:
0.30<|Rasp|/hasp<0.90
−1.00<(Rr+Rf)/(Rr−Rf)<0.00
where Rasp denotes a paraxial radius of curvature of an aspherical surface of the aspherical negative meniscus lens having the shape that negative refractive power is getting smaller from the center to the periphery, hasp denotes a half of an effective diameter (maximum effective radius) of the aspherical negative meniscus lens having the shape that negative refractive power is getting smaller from the center to the periphery, Rr denotes a radius of curvature of the image side surface of the negative lens in the cemented lens, and Rf denotes a radius of curvature of the object side surface of the negative lens in the cemented lens,
an antireflection coating is applied on at least one optical surface of the front lens group, and
the antireflection coating includes at least one layer that is formed by a wet process.

2. The wide-angle lens according to claim 1, wherein the antireflection coating is a multilayered film, and the layer formed by the wet process is the outermost layer among the layers composing the multilayer film.

3. The wide-angle lens according to claim 1, wherein a refractive index at d-line of the layer formed by the wet process is 1.30 or less.

4. The wide-angle lens according to claim 1, wherein an optical surface on which the antireflection coating is applied is a lens surface in the front lens group.

5. The wide-angle lens according to claim 1, wherein an optical surface on which the antireflection coating is applied is a lens surface of the sub-lens group having negative refractive power in the front lens group.

6. The wide-angle lens according to claim 1, wherein an optical surface on which the antireflection coating is applied is an object side lens surface of a convex surface facing the object side.

7. The wide-angle lens according to claim 1, wherein an optical surface on which the antireflection coating is applied is an image side lens surface of a concave surface facing the image side.

8. The wide-angle lens according to claim 1, wherein an optical surface on which the antireflection coating is applied is a lens surface of the aspherical negative meniscus lens.

9. The wide-angle lens according to claim 1, wherein the following conditional expression is satisfied:
0.00<Ff/F0<11.00
where Ff denotes a focal length of the front lens group upon focusing on infinity, and F0 denotes a focal length of the wide-angle lens upon focusing on infinity.

10. The wide-angle lens according to claim 1, wherein the following conditional expression is satisfied:
−0.30<F0/Fb<0.50
where F0 denotes a focal length of the wide-angle lens upon focusing on infinity, and Fb denotes a focal length of the cemented lens.

11. The wide-angle lens according to claim 1, wherein the sub-lens group includes an aspherical lens other than the aspherical negative meniscus lens.

12. The wide-angle lens according to claim 11, wherein the aspherical lens has larger negative refractive power on the periphery than at the center of the lens.

13. The wide-angle lens according to claim 1, wherein the following conditional expression is satisfied:
0.01<(−Fa)/BF<0.80
where Fa denotes a focal length of the sub-lens group, and BF denotes a distance from a vertex of the most image side lens surface to a paraxial image plane.

14. The wide-angle lens according to claim 1, wherein the following conditional expression is satisfied:
4.00<Fr/F0<50.00
where Fr denotes a focal length of the rear lens group upon focusing on infinity, and F0 denotes a focal length of the wide-angle lens upon focusing on infinity.

15. The wide-angle lens according to claim 1, wherein the following conditional expression is satisfied:
0.05<Nn−((Np1+Np2)/2)<0.30
where Nn denotes a refractive index at d-line (wavelength λ=587.6 nm) of the negative lens in the cemented lens, Np1 denotes a refractive index at d-line of the positive lens disposed to the object side in the cemented lens, and Np2 denotes a refractive index at d-line of the positive lens disposed to the image side in the cemented lens.

16. The wide-angle lens according to claim 1, wherein the sub-lens group is composed of negative lenses only.

17. An imaging apparatus equipped with the wide-angle lens according to claim 1.

18. A method for manufacturing a wide-angle lens including a front lens group disposed to an object side of an aperture stop, and a rear lens group disposed to an image side of the aperture stop comprising steps of:
disposing optical members including at least three negative lenses including an aspherical negative meniscus lens having a shape that negative refractive power is getting weaker from the center to the periphery into a sub-lens group disposed to the object side of the front lens group;
disposing optical members including a cemented lens constructed by a positive lens, a negative lens, and a positive lens to the image side of the sub-lens group;
applying an antireflection coating on at least one optical surface of the front lens group, and the antireflection coating including at least one layer that is formed by a wet process; and
satisfying the following conditional expressions:
0.30<|Rasp|/hasp<0.90
−1.00<(Rr+Rf)/(Rr−Rf)<0.00
where Rasp denotes a paraxial radius of curvature of an aspherical surface of the aspherical negative meniscus lens having the shape that negative refractive power is getting weaker from the center to the periphery, hasp denotes a half of an effective diameter (maximum effective radius) of the aspherical negative meniscus lens having the shape that negative refractive power is getting weaker from the center to the periphery, Rr denotes a radius of curvature of the image side surface of the negative lens in the cemented lens, and Rf denotes a radius of curvature of the object side surface of the negative lens in the cemented lens.
